(19) United States
(12) Patent Application Publication
(10) Pub. No.: US 2014/0224839 A1
(43) Pub. Date: Aug. 14, 2014

(54) DRUG DISPENSING UNIT AND DRUG DISPENSING DEVICE INCLUDING THE SAME

(71) Applicant: JVM CO., LTD., Daegu (KR)

(72) Inventor: Jun Ho KIM, Daegu (KR)

(73) Assignee: JVM CO., LTD., Daegu (KR)

(21) Appl. No.: 14/163,631

(22) Filed: Jan. 24, 2014

(30) Foreign Application Priority Data
Feb. 13, 2013 (KR) 10-2013-0015365

(51) Int. Cl. B67D 7/06

(52) U.S. Cl. CPC B67D 7/06
USPC 222/135

(57) ABSTRACT

Provided is a drug dispensing unit. The drug dispensing unit that rotates a dispensing part to dispense at least one drug from a drug storage box through which the drug is dispensed by an operation of the dispensing part, the drug dispensing unit includes a position moving part moved in position to contact the dispensing part, the position moving part including a dispensing part rotating part to allow the dispensing part to rotate, a rotation force supply part generating driving force for providing rotation force to the dispensing part rotating part, the rotation force supply part being disposed adjacent to the position moving part, and a position moving power supply part disposed adjacent to the position moving part to provide the driving force with respect to the position movement of the position moving part.

### CROSS-REFERENCE TO RELATED PATENT APPLICATION

This application claims the benefit of Korean Patent Application No. 10-2013-0015365, filed on Feb. 13, 2013, in the Korean Intellectual Property Office, the disclosure of which is incorporated herein in its entirety by reference.

### BACKGROUND OF THE INVENTION

1. Field of the Invention

The present invention relates to a drug dispensing unit and a drug dispensing device including the same, and more particularly, to a drug dispensing unit for dispensing drugs from a drug storage box in which the drugs are accommodated and a drug dispensing device including the same.

2. Description of the Related Art

In general, a dose of drug according to a patient's prescription may include various kinds and types of drugs. The dose of drug classified according to the patient's prescription may be transferred to the patient in a state of being contained in a basket.

Drugs to be contained in one basket are collected into one basket from boxes, in which various kinds of drugs are contained, according to kinds and numbers of drugs written on a patient's prescription. Then, the basket in which the corresponding drugs are collected is transferred to the patient, and the patient takes the drugs collected in the basket.

In conventional ways, to collect various drugs into one basket, medical experts such as pharmacists have to manually take drugs out of drug-containing bottles one by one according to the patient's prescription. As a result, it is necessary to execute a confirmation work for redetermining accuracy in the collection of the drugs.

There is possibility of occurrence of drug misadventure because it is difficult to secure accuracy in administration. Also, it takes a long time to collect drugs according to a patient's prescription because the collection process is complicated to deteriorate working efficiency in addition to the possibility of the occurrence of the drug misadventure.

Thus, studies with respect to methods and technologies for improving accuracy and efficiency in the collection of drugs for each unit dose according to the patient's medical prescription to provide convenience of uses such as pharmacists and previously prevent drug misadventure from occurring are needed.

### SUMMARY OF THE INVENTION

The present invention provides a drug dispensing unit that accurately dispenses drugs from a drug storage box as well as dispenses a plurality of drugs at the same time to improve efficiency in drug dispensing when drugs are collected according to a patient's prescription and a drug dispensing device including the same.

The technical objects of the present invention are not limited to those described above, and it will be apparent to those of ordinary skill in the art from the following description that the present invention includes other technical objects not specifically mentioned herein.

According to an aspect of the present invention, there is provided drug dispensing unit that rotates a dispensing part to dispense at least one drug from a drug storage box through which the drug is dispensed by an operation of the dispensing part, the drug dispensing unit including: a position moving part having a dispensing part rotating part being moved to contact the dispensing part to allow the dispensing part to rotate; a rotation force supply part generating driving force for providing rotation force to the dispensing part rotating part, the rotation force supply part being disposed adjacent to the position moving part; and a position moving power supply part disposed adjacent to the position moving part to provide the driving force with respect to the position movement of the position moving part.

The position moving power supply part may include a pinion gear, and the position moving part may include a rack gear that is linearly moved by rotation of the pinion gear to allow the dispensing part rotating part to contact the dispensing part of the drug storage box.

The position moving part may include a rack gear part on which the rack gear is disposed and a rotation support part connected to the rack gear part to rotatably support the dispensing part rotating part.

The rotation support part may be rotatably connected to the rack gear to improve transmission of the rotation driving force from the dispensing part rotating part due to the contact of the dispensing part.

The rotation of the rotation support part by the rack gear may be realized within a limited range by a restoring member disposed on a rotation shaft.

The position moving power supply part may include a worm gear including a worm and a worm wheel to change a rotation direction, and the worm wheel may be interlocked with the pinion gear to rotate in the same direction as that of the pinion gear.

The rotation support part may include a rotation power interlocking part interlocked with the rotation power supply part to rotate so that the driving force generated by the rotation power supply part is transmitted into the dispensing part rotating part.

The drug dispensing unit may further include a position moving support part disposed on each of both sides of the position moving part to support the position movement of the position moving part.

The position moving support part may include position fixing parts disposed on both sides of the position moving part to prevent the position moving part from being separated and at least one support shaft connecting the position fixing parts to each other, and the position moving part may include a through hole through which the support shaft passes to allow the support shaft to be disposed between the position fixing parts.

The through hole may be successively defined along a position movement direction of the position moving part to define a position movement range of the position moving part.

The drug dispensing unit may further include a movement detection part disposed on a side of the position moving part to detect whether the position moving part is moved.

The position moving part may include an extension part extending toward the movement detection part, and the movement detection part may be provided in at least two within a moving range of the position moving part to detect whether the extension part is moved.

According to another aspect of the present invention, there is provided a drug dispensing device including at least one floor and mounted on drug dispensing equipment, in which a plurality of drug storage boxes for accommodating drugs are mounted on each floor, to operate a dispensing part of each of the drug storage boxes, thereby dispensing at least one drug, the drug dispensing device including: a first drug dispensing unit to an N-th drug dispensing unit according to any one of claims 1 to 12, the first drug dispensing unit to the N-th drug dispensing unit being disposed to correspond to the drug storage boxes mounted on the one floor, wherein the first drug dispensing unit to the N-th drug dispensing unit rotate the dispensing part of the drug storage box, in which a drug to be dispensed is accommodated, to dispense the desired drug (where, N is natural number).

Only a position moving part of the drug dispensing unit corresponding to the drug storage box in which the drug to be dispensed is accommodated among the first drug dispensing unit to the N-th drug dispensing unit may be moved in position.

Only a rotation power supply part of the drug dispensing unit, which is moved in position, among rotation power supply parts of the first drug dispensing unit to the N-th drug dispensing unit may generate driving force.

At least one of rotation power supply parts of the drug dispensing units, which are moved in position, and rotation power supply parts of the drug dispensing units, which are not moved in position, among the rotation power supply units of the first drug dispensing unit to the N-th drug dispensing unit may generate driving force.

At least one of position moving parts of the drug dispensing units corresponding to the drug storage boxes, in which drugs to be dispensed are accommodated, and position moving parts of the drug dispensing units corresponding to the drug storage boxes, in which drugs that are not dispensed are accommodated, among the position moving parts of the first drug dispensing unit to the N-th drug dispensing unit may be moved to the corresponding drug storage box, and only a rotation power supply part of the drug dispensing unit corresponding to the drug storage box in which the drugs to be dispensed are accommodated may generate driving force.

When the drug storage box required for dispensing drugs is provided in plurality, the first drug dispensing unit to the N-th drug dispensing unit may simultaneously or successively rotate the dispensing parts of the plurality of drug storage boxes required for dispensing the drugs so that the drugs are dispensed from the plurality of drug storage boxes required for dispensing the drugs.

Portions of the first drug dispensing unit to the N-th drug dispensing unit may be disposed at the same height to form a first drug dispensing unit floor, and remaining portions of the first drug dispensing unit to the N-th drug dispensing unit may be disposed at the same height on a side of the first drug dispensing unit floor to form a second dispensing unit floor.

Dispensing part rotating parts of the drug dispensing units constituting the second drug dispensing unit floor may have the same height as those of dispensing part rotating parts of the drug dispensing units constituting the first drug dispensing unit floor.

### BRIEF DESCRIPTION OF THE DRAWINGS

The above and other features and advantages of the present invention will become more apparent by describing in detail exemplary embodiments thereof with reference to the attached drawings in which:

FIG. 1 is schematic perspective view of drug dispensing equipment according to the present invention;

FIGS. 2 and 3 are schematic views for explaining a principle in which drugs are dispensed from a drug storage box by using a drug dispensing device according to the present invention;

FIGS. 4 and 5 are schematic perspective view of a drug dispensing unit according to an embodiment of the present invention;

FIG. 6 is a schematic exploded perspective view of the drug dispensing unit according to an embodiment of the present invention;

FIG. 7 is a schematic perspective view of a state in which a position moving part of the drug dispensing unit moves in position according to an embodiment of the present invention;

FIGS. 8 and 9 are schematic views of a state in which a rotation support part of the drug dispensing unit rotates according to an embodiment of the present invention;

FIG. 10 is a schematic partial exploded perspective view of a drug dispensing unit according to another embodiment of the present invention;

FIG. 11 is a schematic perspective view of a state in which a position moving part of the drug dispensing unit moves in position according to another embodiment of the present invention;

FIG. 12 is schematic perspective view of a drug dispensing device according to the present invention;

FIG. 13 is schematic perspective view illustrating an operation state of the drug dispensing device according to the present invention;

FIG. 14 is schematic perspective view illustrating another operation state of the drug dispensing device according to the present invention;

FIG. 15 is schematic perspective view illustrating another operation state of the drug dispensing device according to the present invention;

FIG. 16 is schematic perspective view for explaining that the drug dispensing device is applied to drug storage boxes having various sizes according to the present invention; and

FIG. 17 is schematic perspective view illustrating an operation state in case of FIG. 16.

### DETAILED DESCRIPTION OF THE INVENTION

Hereinafter, exemplary embodiments of the present invention will be described with reference to the accompanying drawings. The invention may, however, be embodied in many different forms and should not be construed as being limited to the embodiments set forth herein; rather, that alternate embodiments included in other retrogressive inventions or falling within the spirit and scope of the present disclosure will fully convey the concept of the invention to those skilled in the art.

Also, note that elements having the same function are denoted by the same reference symbol in principle throughout all the drawings for explaining the embodiments.

[Drug Dispensing Equipment]

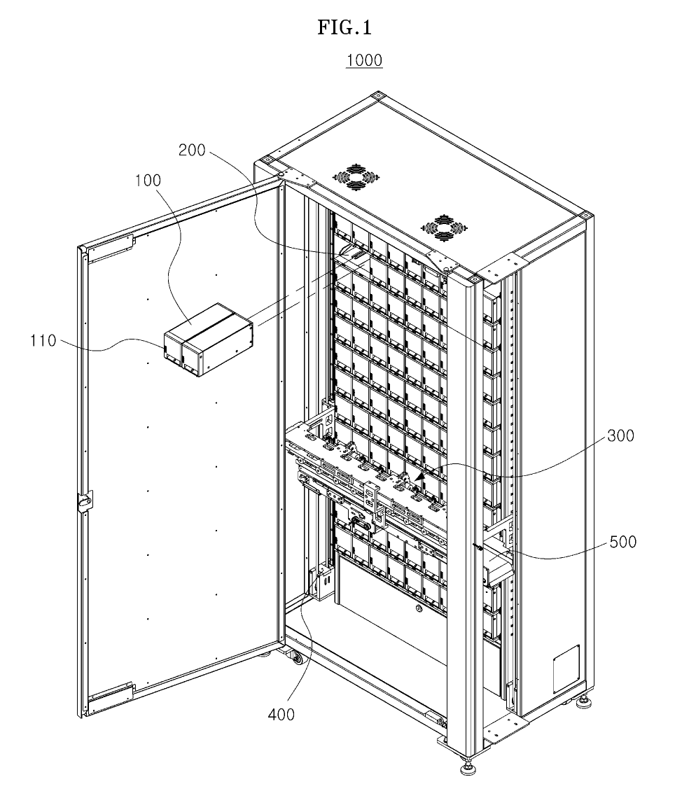

FIG. 1 is schematic perspective view of drug dispensing equipment according to the present invention.

Referring to FIG. 1, drug dispensing equipment 1000 according to the present invention may include a drug storage box 100 for accommodating at least one drug, a cartridge 200 for mounting the drug storage box 100 on the drug dispensing equipment 1000, a drug dispensing device 300 for dispensing the drug accommodated in the drug storage box 100, and a drug dispensing device moving unit 400 for moving the drug dispensing device 300 into each floor within the drug dispensing equipment 1000.

In the drug dispensing equipment 1000 according to the present invention, a plurality of drug storage boxes may be mounted on the cartridge 200. The cartridge 200 may be provided for each floor of the drug dispensing equipment 1000.

At least one cartridge 200 may be provided on each floor of the drug dispensing equipment 1000. The number of drug storage box 100 mounted on one cartridge 200 may variously vary according to the intension of persons skilled in the art.

Here, the drug dispensing equipment 1000 may operate, i.e., rotate a dispensing part 110 of the drug storage box 100 for accommodating at least one drug by the drug dispensing device 300 to realize the dispensing of the drug. The drug storage box 100 may be detachably inserted into and mounted on the cartridge 200.

The drug dispensed to the outside by the drug dispensing device 300 may be seated on a conveyer unit 500. That is, the drug may vary in position due to a rotational movement of a belt of the conveyer unit 500 and thus be collected into a predetermined external space.

The movement for each floor of the drug dispensing apparatus 300 may be realized by the drug dispensing device moving unit 400. The drug dispensing device moving unit 400 may move the drug dispensing device 300 onto a floor, on which the drug storage box 100, in which a desired packaged drug is accommodated, is disposed, by an external signal.

That is to say, when a signal according to a patient's prescription is applied to the drug dispensing equipment 1000 according to the present invention, the drug dispensing device moving unit 400 moves the drug dispensing device 300 onto a desired floor, and then, a dispensing part 110 of the drug storage box 100 rotates by the drug dispensing device 300 to dispense the desired packaged drug from the drug storage box 100.

The dispensed drug may be seated on the conveyer unit 500. The conveyer unit 500 on which the drug is seated may be moved to a position corresponding to a preset dispensing space by the drug dispensing device moving unit 400. Then, the belt of the conveyer unit 500 may rotate to move the drug seated thereon to the predetermined external space, thereby collecting the drug.

However, the present invention is not limited to the above-described structure in which the rotational movement of the belt of the conveyer unit 500 is performed after the conveyer unit 500 is moved to the position corresponding to the preset dispensing space. For example, the conveyer unit 500 may rotate before the conveyer unit 500 is moved to the position corresponding to the preset dispensing space.

If drugs according to the patient's prescription are accommodated into a plurality of drug storage boxes 100 disposed on each floor and drug storage boxes 100 disposed on several floors, the drug dispensing device 300 may be moved to one floor by the drug dispensing device moving unit 400 to dispense packaged drugs from the plurality of drug storage boxes 100 disposed on the corresponding floor in order or at the same time. When the dispensing of the packaged drugs from one floor is completed, the drug dispensing device 300 may be moved to the other floor to dispense packaged drugs from the drug storage boxes 100 disposed on the other floor.

As described above, when the dispensing of the drugs according to the patient's prescription from the plurality of drug storage boxes 100 is completed, the conveyer unit 500 on which the plurality of drugs are seated may be moved to the position corresponding to the preset dispensing space by the drug dispensing device moving unit 400. Then, the plurality of drugs seated on the conveyer unit 500 may be moved by the rotation of the belt of the conveyer unit 500 and be collected into the predetermined external space.

[Principle for Dispensing Drug from Drug Storage Box]

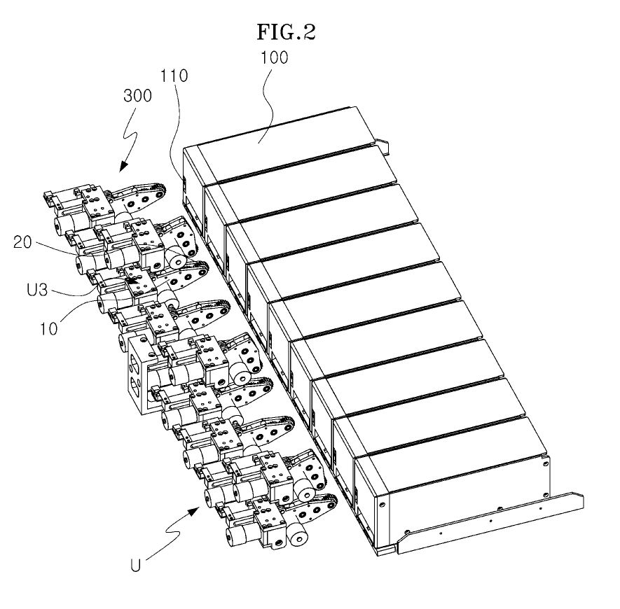

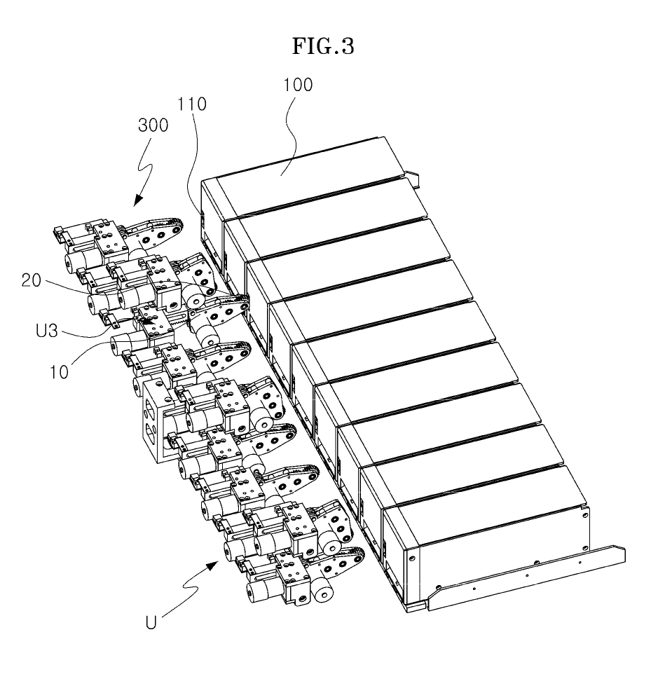

FIGS. 2 and 3 are schematic views for explaining a principle in which drugs are dispensed from a drug storage box by using a drug dispensing device according to the present invention.

Referring to FIGS. 2 and 3, the dispensing of drugs from the drug storage box 100 may be realized by an operation, i.e., rotation of the dispensing part 110 exposed to a front side of the drug storage box 100. The rotation of the dispensing part 110 may be realized by the movement in position of a drug dispensing unit U of the drug dispensing device 300.

The drug dispensing unit U may be one component constituting the drug dispensing device 300. A plurality of drug dispensing units U belong together to realize one drug dispensing device 300.

Hereinafter, a principle for dispensing drugs when it is assumed that drugs to be dispensed are accommodated into one drug storage box 100 will be described.

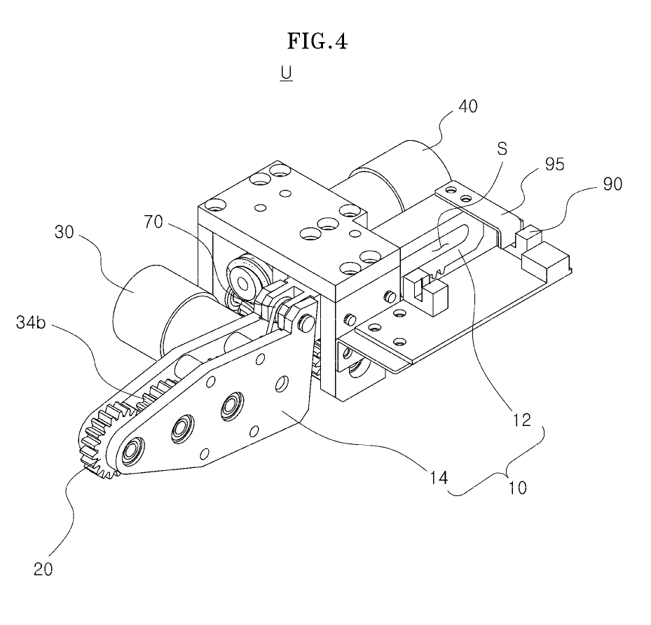

The drug dispensing device 300 may be moved to a position corresponding to the drug storage box 100, in which the drugs to be dispensed are accommodated, by the drug dispensing device moving unit 400. When the movement of the drug dispensing device 300 is completed, a position moving part 10 (see FIG. 4) of a drug dispensing unit U4 (hereinafter, referred to a third drug dispensing unit) of a plurality of drug dispensing units U corresponding to the drug storage box 100 in which the drugs to be dispensed are accommodated may be moved.

The position moving part 10 of the third drug dispensing unit U3 may be moved toward the drug storage box 100 according to an external signal. As a result, a dispensing part rotating part 20 disposed on the position moving part 10 is engaged with the dispensing part 110.

In this case, when the dispensing part rotating part 20 rotates, the dispensing part 110 may be interlocked with the dispensing part rotating part 20, and thus, the dispensing part 110 may also rotate due to the rotation of the dispensing part rotating part 20.

The drug accommodated in the drug storage box 100 may be dispensed to the conveyer unit 500, which is disposed outside the drug storage box 100, by the rotation of the dispensing part 110. The drug seated on the conveyer unit 500 may be collected into a predetermined external space by rotation movement of the belt.

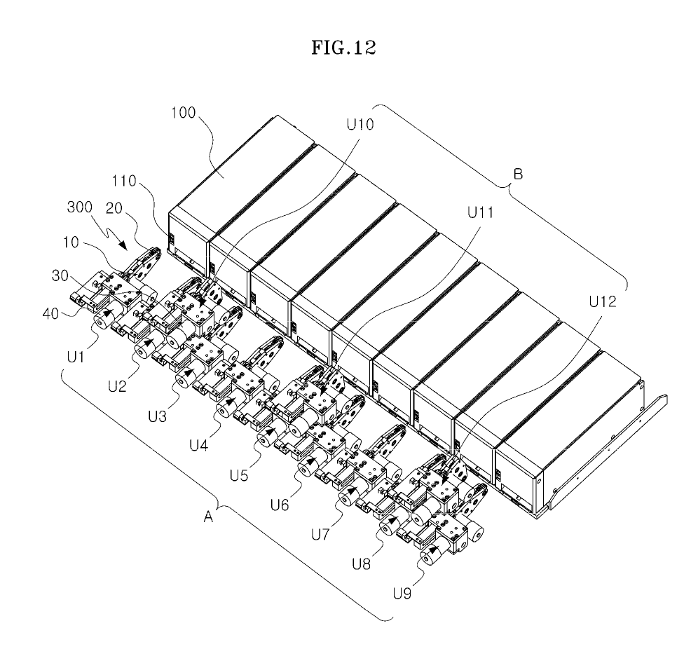

Here, the position moving part 20 that is moved in position is not limited to the fourth drug dispensing unit U4, and also, detailed descriptions thereof will be described below with reference to FIGS. 12 to 17.

[Drug Dispensing Unit]

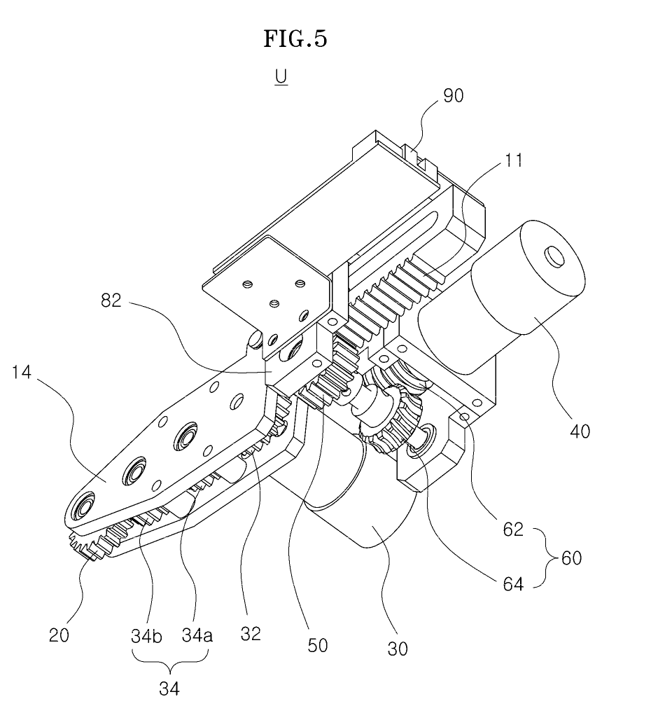

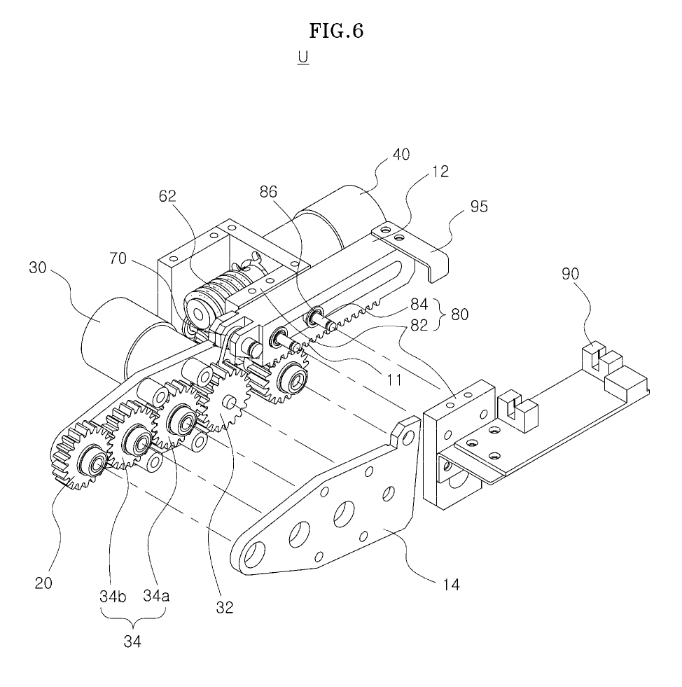

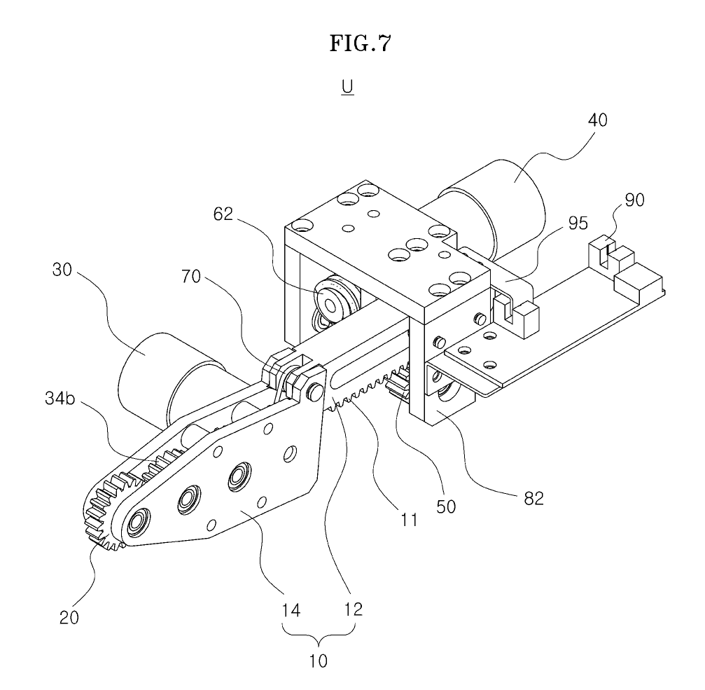

FIGS. 4 and 5 are schematic perspective view of a drug dispensing unit according to an embodiment of the present invention, FIG. 6 is a schematic exploded perspective view of the drug dispensing unit according to an embodiment of the present invention, and FIG. 7 is a schematic perspective view of a state in which a position moving part of the drug dispensing unit moves in position according to an embodiment of the present invention.

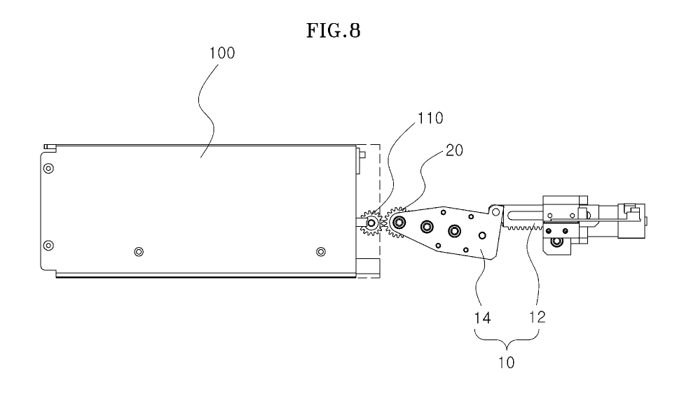

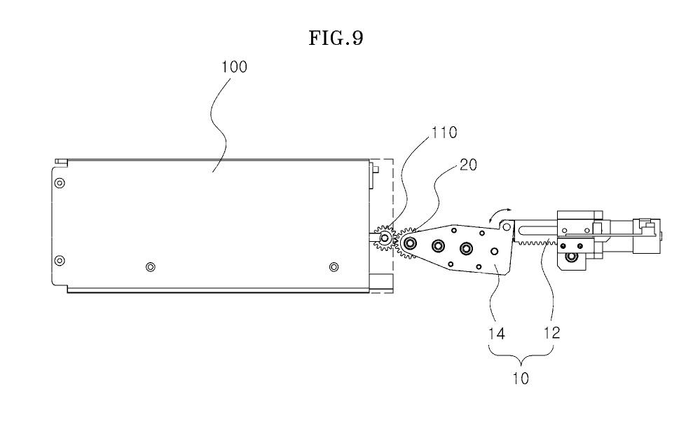

FIGS. 8 and 9 are schematic views of a state in which a rotation support part of the drug dispensing unit rotates according to an embodiment of the present invention.

Referring to FIGS. 4 to 7, a drug dispensing unit U may be one component constituting a drug dispensing device 300. The drug dispensing unit U may include a position moving part 10 including a dispensing part rotating part 20 that is moved to contact a dispensing part 110 of a drug storage box 100 to allow the dispensing part 110 to rotate, a rotation power supplying part 30 generating driving force for providing rotation force to the dispensing part rotating part 20, and a position moving power supply part 40 providing driving force with respect to the position movement of the position moving part 10.

Here, the rotation power supply part 30 and the position moving power supply part 40 may be disposed adjacent to the position moving part 10. Also, each of the rotation power supply part 30 and the position moving power supply part 40 may be a kind of small motor for generating rotation force.

Here, the position moving power supply part 40 may operate by an external signal to generate rotation force. The rotation force may rotate a pinion gear 50.

The movement in position of the position moving part 10 may be realized by the rotation of the pinion gear 50.

In detail, the position moving part 10 may include a rack gear 11 that is linearly moved by the rotation of the pinion gear 50 to allow the dispensing part rotating part 20 to contact the dispensing part 110 of the drug storage box 100. Here, the rack gear 11 may be a kind of segment gear.

The rack gear 11 may be disposed on a bottom surface of the position moving part 10. As the pinion gear 50 rotates, the rack gear 11 may be linearly moved to move the position moving part 10.

Here, the rotation of the pinion gear 50 may be realized by a worm gear 60. The worm gear 60 may include a worm 62 and a worm wheel 64.

That is to say, the position moving power supply part 40 may include the worm gear 60 and the pinion gear 50. Also, the rotation direction may be changed by the worm gear 60 including the worm 62 and the worm wheel 64.

The worm wheel 64 rotating in a direction different form that of the worm 62 may be interlocked with the pinion gear 50 to rotate in the same direction as that of the pinion gear 50. This is done because the worm wheel 64 and the pinion gear 50 share the same rotation shaft.

Thus, the rotation power generated by the position moving power supply part 40 may rotate the worm 62. As the worm 62 rotates, the worm wheel 64 may rotate. Also, as the worm wheel 64 rotates, the pinion gear 50 may rotate.

The rotation of the pinion gear 50 may allow the rack gear 11 of the position moving part 10 to be linearly moved. Thus, the dispensing part rotating part 20 may contact the dispensing part 110 of the drug storage box 100 due to the linear movement of the position moving part 10.

The position moving part 10 may include a rack gear part 12 on which the rack gear 11 is disposed and a rotation support part 14 connected to the rack gear part 12 to rotatably support the dispensing part rotating part 20.

The rotation support part 14 may be rotatably connected to the rack gear part 12. Thus, the transmission of the rotation driving force from the dispensing part rotating part 20 to the dispensing part 110 due to the contact therebetween may be improved.

Referring to FIGS. 8 and 9, each of the dispensing part rotating part 20 and the dispensing part 110 may be provided as a kind of gear. In order to rotate the dispensing part 110 due to the rotation of the dispensing part rotating part 20, the dispensing part rotating part 20 and the dispensing part 110 have to be engaged with each other.

Here, when the position moving part 110 is moved toward the drug storage box 100 by the driving force of the position moving power supply part 40, gear teeth of the dispensing part rotating part 20 may collide with gear teeth of the dispensing part 110.

In this case, the dispensing part rotating part 20 may be vertically moved to be engaged with the dispensing part 110. According to the present invention, this may be realized through the rotation from the rack gear part 12 of the rotation support part 14.

The rotation of the rotation support part 14 by the rack gear 12 may be realized within a limited range by a restoring member 70 disposed on a rotation shaft. The rotation generated while the dispensing part rotating part 20 is engaged with the dispensing part 110 may allow the dispensing part rotating part 20 to rotate the dispensing part 110, thereby dispensing the drug. Then, when the drug is separated, the rotation support part 14 may return to its original position by the restoring member 70.

The rotation of the dispensing part rotating part 20 may be realized by the rotation power supply part 30 disposed adjacent to the position moving part 10. The driving force of the rotation power supply part 30 may be transmitted to the dispensing part rotating part 20 by a rotation power interlocking part 32.

The rotation power interlocking part 32 may be one component of the rotation support part 14 and be a kind of gear. The rotation power of the rotation power interlocking part 32 may be transmitted to the dispensing part rotating part 20 by a rotation power transmission part 34.

The rotation power transmission part 34 may be one component of the rotation support part 14 disposed to contact the rotation power interlocking part 32 and be a kind of gear. Thus, the rotation force of the rotation power interlocking part 32 may be transmitted to the dispensing part rotating part 20.

The rotation power transmission part 34 may include a first rotation power transmission part 34a disposed to contact the rotation power interlocking part 32 and a second rotation power transmission part 34b disposed to contact the first rotation power transmission part 34a and the dispensing part rotating part 20.

Thus, the rotation power interlocking part 32, the rotation power transmission part 34, and the dispensing part rotating part 20 may be engaged with each other. As a result, the rotation power of the rotation power supply part 30 may be finally transmitted to the dispensing part rotating part 20.

However, the present invention is not limited to the above-described structure in which the rotation power of the rotation power supply part 30 is transmitted to the dispensing part rotating part 20 by the plurality of gears. For example, the rotation power supply part 30 may directly rotate the dispensing part rotating part 20. Alternatively, the rotation power interlocking part 32 may be engaged with the dispensing part rotating part 20 without the rotation power transmission part 34.

Also, the present invention is not limited to the above-described structure in which the rotation power interlocking part 32, the rotation power transmission part 34, and the dispensing part rotating part 20 are provided as the gears. For example, the rotation power interlocking part 32, the rotation power transmission part 34, and the dispensing part rotating part 20 may be provided as chains or belts.

The movement in position of the position moving part 10 by the position moving power supply part 40 may be supported by a position moving support part 80. The position moving support part 80 may be disposed on each of both sides of the position moving part 10.

The position moving support part 80 may be a kind of fixed structure that supports the movement of the position moving part 10 in aspect of the position moving part 10. The position moving support part 80 may include position fixing parts 82 and at least one support shaft 84.

The position fixing parts 82 may be kind of separation preventing walls that prevent the position moving part 10 from being separated. The support shaft 84 may be a connection shaft for connecting the position fixing parts 82 to each other.

Here, the position moving part 10 may have a through hole S through which the support shaft 84 passes to allow the support shaft 84 to be disposed between the position fixing parts 80. The through hole S may be successively formed along a position moving direction of the position moving part 10.

A position moving range of the position moving part 10 may be defined by the through hole S. The position moving part 10 may be moved to the drug storage box 100 in the state where the support shaft 84 passes through the through hole S.

Here, the movement of the position moving part 10 may be guided by a guide part 86 coupled to the support shaft 84. The guide part 86 may contact a wall that defines the through hole S to guide the position movement of the position moving part 10.

Although the position moving part 10 may be slid in a state where the position moving part 10 is in contact with the guide part 86, the guide part 86 may be provided as a ball bearing to guide the position movement due to the rotation of the ball bearing.

The drug dispensing unit U according to an embodiment of the present invention may detect whether the position moving part 10 is moved by using a movement detection part 90.

The movement detection part 90 may be disposed on a side of the position moving part 10.

Here, the movement detection part 90 may detect whether an extension part 95 of the position moving part 10, which extends to the movement detection part 90, is moved. For example, at least two movement detection parts 90 may be provided within the moving range of the position moving part 10 to detect whether the extension part 95, i.e., the position moving part 10 is moved.

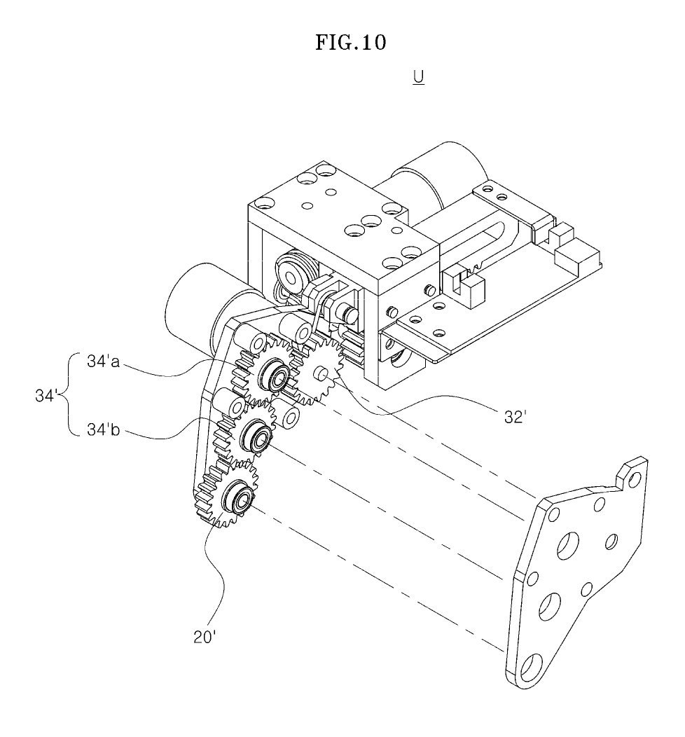

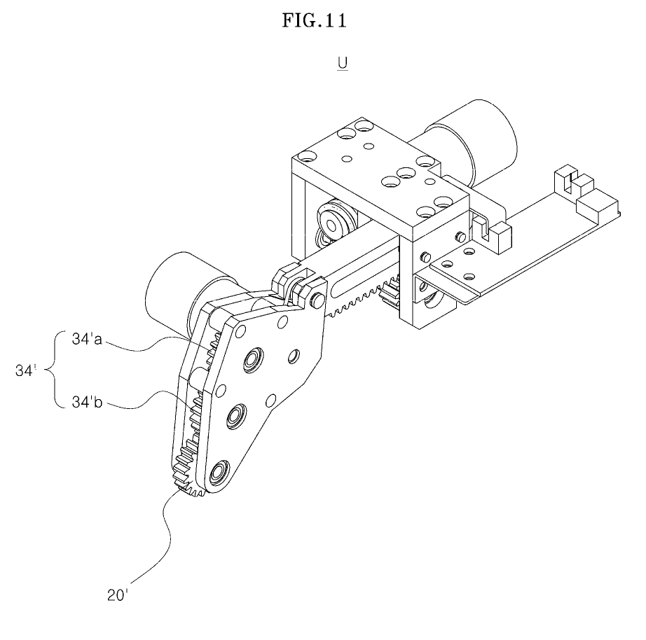

FIG. 10 is a schematic partial exploded perspective view of a drug dispensing unit according to another embodiment of the present invention, and FIG. 11 is a schematic perspective view of a state in which a position moving part of the drug dispensing unit moves in position according to another embodiment of the present invention.

Referring to FIGS. 10 and 11, a drug dispensing unit U′ according to another embodiment of the present invention has the same constitution and effect as those of the drug dispensing unit U, which is described with reference to FIGS. 4 to 9, according to the foregoing embodiment, except for an arrangement relationship between a rotation power interlocking part 32′, a rotation power transmission part 34′, and a dispensing part rotating part 20′. Thus, descriptions except for the arrangement relationship between the rotation power interlocking part 32′, the rotation power transmission part 34′, and the dispensing part rotating part 20′ will be omitted.

The rotation power transmission part 34′ may include a first rotation power transmission part 34a′ and a second rotation power transmission part 34b′. The rotation power interlocking part 32′, the first rotation power transmission part 34a′, the second rotation power transmission part 34b′ , and the dispensing part rotating part 20′ may be disposed in a “ [symbol] ” shape on the whole.

This is done due to a height of the drug dispensing unit U1 within the drug dispensing equipment 1000. That is, this is done because a second drug dispensing unit floor B is provided, and this will be described below.

[Drug Dispensing Device]

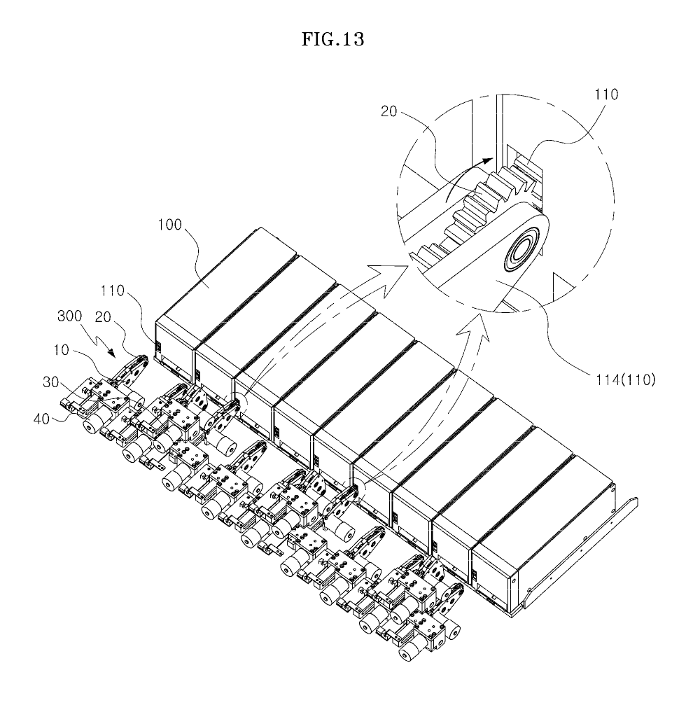

FIG. 12 is schematic perspective view of a drug dispensing device according to the present invention, and FIG. 13 is schematic perspective view illustrating an operation state of the drug dispensing device according to the present invention.

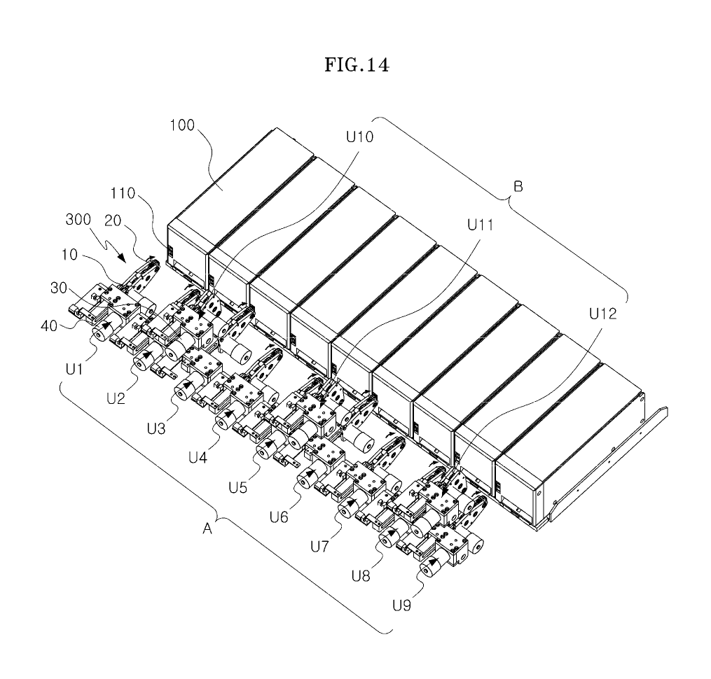

FIG. 14 is schematic perspective view illustrating another operation state of the drug dispensing device according to the present invention.

Referring to FIG. 12, a drug dispensing device 300 includes at least one floor. A plurality of drug storage boxes 100 in which a drug is accommodated onto the floor may be mounted on a drug dispensing equipment 100. Thus, the drug dispensing device 300 may be a drug dispensing structure for dispensing at least one drug by rotating a dispensing part 110 of each of the drug storage boxes 100.

In detail, the drug dispensing device 300 may include a first drug dispensing unit to an N-th drug dispensing unit which are disposed to correspond to the drug storage boxes mounted on the one floor. The first drug dispensing unit to the N-th drug dispensing unit may rotate the dispensing part 110 of the drug storage box 100, in which a drug to be dispensed is accommodated, to dispense the desired drug (where, N is natural number).

Also, if the drug storage box 100 required for dispensing drugs is provided in plurality, the first drug dispensing unit to the N-th drug dispensing unit may simultaneously or successively rotate the dispensing parts 110 of the plurality of drug storage boxes 100 required for dispensing the drugs so that the drugs are dispensed from the plurality of drug storage boxes 100 required for dispensing the drugs.

Thus, the drug dispensing device 300 according to the present invention may accurately dispense desired drugs from the drug storage boxes 100 according to a patient's prescription as well as improve drug dispensing efficiency.

Also, portions of the first drug dispensing unit to the N-th drug dispensing unit may be disposed at the same height to form a first drug dispensing unit floor A, and remaining portions of the first drug dispensing unit to the N-th drug dispensing unit may be disposed at the same height on a side of the first drug dispensing unit floor A to form a second drug dispensing unit floor B.

Here, dispensing part rotating parts of the drug dispensing units constituting the second drug dispensing unit floor B may have the same height as those of the drug dispensing units constituting the first drug dispensing unit floor A.

This may be realized by disposing the rotation power interlocking parts 32′, the first rotation power transmission parts 34a′, the second rotation power transmission parts 34b′, and the dispensing part rotating parts 20′ of the drug dispensing units constituting the second drug dispensing unit floor B in a “ [symbol] ” shape on the whole (see FIGS. 10 and 11).

Also, the first drug dispensing unit floor A and the second drug dispensing unit floor B which are disposed at heights different from each other are to correspond to widths of the various drug storage boxes 100. If drugs are dispensed from the drug storage box 100 having a relatively large width, the drug dispensing units constituting the first drug dispensing unit floor A and the drug dispensing units constituting the second drug dispensing unit floor B may be applied at the same time.

However, if drugs are dispensed from the drug storage box 100 having a relatively small width, the drugs may be dispensed from only drug dispensing units constituting the first drug dispensing unit floor A.

That is to say, if the drug storage box 100 has a relatively small width as shown in FIGS. 12 and 13, the drug dispensing unit corresponding to the drug storage box 100 may be a drug dispensing unit included in the first drug dispensing unit floor A.

Hereinafter, a case in which N is 12, and the drug storage box 100 has a relatively small width will be described as an example. Also, an operation state of a case in which drugs accommodated in the drug storage boxes 100 that respectively correspond to a third drug dispensing unit U3 and a sixth drug dispensing unit U6 are dispensed by the drug dispensing device 300 according to the present invention will be described as an example.

Referring to FIG. 13, the drug dispensing device 300 may be moved to a position corresponding to the drug storage box 100, in which the drugs to be dispensed are accommodated, by the drug dispensing device moving unit 400. When the movement of the drug dispensing device 300 is completed, position moving power supply parts 40 of the third drug dispensing unit U3 and the sixth drug dispensing unit U6 may operate by an external signal.

A position moving part 10 of the third drug dispensing unit U3 and a position moving part 10 of the sixth drug dispensing unit U6 may be respectively moved to the drug storage boxes 100 corresponding thereto by driving force supplied from position moving power supply parts 40 of the third drug dispensing unit U3 and the sixth drug dispensing unit U6. Here, each of the dispensing part rotating parts 20 may be engaged with a dispensing part 110 of each of the drug storage boxes 100.

Here, if gear teeth of the dispensing part rotating part 20 and the dispensing part 110 collide with each other, the dispensing part rotating part 20 and the dispensing part 110 may be corrected so that the teeth of the dispensing part rotating part 20 and the dispensing part 110 are engaged with each other by the rotation of the rotation support part 14 due to the rack gear 12 (see FIGS. 8 and 9).

Thereafter, a rotation power supply part 30 of the third drug dispensing unit U3 and a rotation power supply part 30 of the sixth drug dispensing unit U6 may generate driving force to rotate the dispensing part rotating parts 20, respectively. Therefore, the dispensing parts 110 of the drug storage boxes 100 may rotate to dispense the desired drugs onto a conveyer part 500.

However, referring to FIG. 14, the operation of the rotation power supply part 30 for generating driving force may not be limited to the third drug dispensing unit U3 and the sixth drug dispensing unit U6. For example, at least one rotation power supply part 30 of drug dispensing units U1, U2, U4, U5, and U7 to U12 except for the third drug dispensing unit U3 and the sixth drug dispensing unit U6 may operate.

When the desired drugs are completely dispensed, the rotation of the rotation power supply parts 30 of the third and sixth drug dispensing units U3 and U6 may be stopped to block the driving force. As a result, each of the position moving parts 10 may return to its original position by the driving force of each of position moving power supply parts 40 of the third and sixth drug dispensing units U3 and U6.

Here, a position movement direction of each of the third and sixth drug dispensing units U3 and U6 due to the position moving power supply parts 40 may be realized by converting a rotation direction of the position moving power supply part 40.

If at least two desired drugs exist in the same floor, the position moving parts 10 corresponding to the at least two drugs may be moved to dispense the at least two drugs at the same time by the driving force of the corresponding rotation power supply parts 30.

However, the present invention is not limited to the above-described feature in which the movement of the position moving part 10 and the generation of the driving force of the rotation power supply part 30 are performed at the same time. For example, the movement of the position moving part 10 and the generation of the driving force of the rotation power supply part 30 may be successively performed.

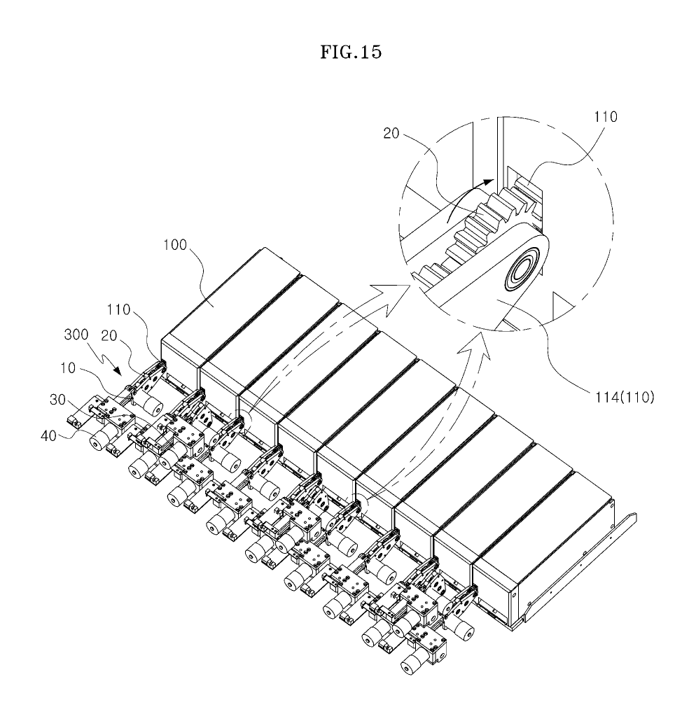

FIG. 15 is schematic perspective view illustrating another operation state of the drug dispensing device according to the present invention.

Referring to FIG. 15, the drug dispensing device 300 may be moved to a position corresponding to the drug storage box 100, in which the drugs to be dispensed are accommodated, by the drug dispensing device moving unit 400. When the movement of the drug dispensing device 300 is completed, the position moving power supply parts 40 of the third drug dispensing unit U3 and the sixth drug dispensing unit U6 as well as the position moving power supply part 40 of at least one of the drug dispensing units U1, U2, U4, U5, and U7 to U12 may operate.

Hereinafter, a case in which the position moving power supply parts 40 of the first to ninth drug dispensing units U1 to U9 operate will be described as an example.

The position moving part 10 of the first drug dispensing unit U1 to the position moving part 10 of the ninth drug dispensing unit U9 may be respectively moved to the drug storage boxes 100 corresponding thereto by driving force supplied from position moving power supply parts 40 of the first drug dispensing unit U1 to the ninth drug dispensing unit U9. Here, each of the dispensing part rotating parts 20 may be engaged with a dispensing part 110 of each of the drug storage boxes 100.

Thereafter, the rotation power supply part 30 of the third drug dispensing unit U3 and the rotation power supply part 30 of the sixth drug dispensing unit U6 may generate driving force to rotate the dispensing part rotating parts 20, respectively. Therefore, the dispensing parts 110 of the drug storage boxes 100 may rotate to dispense the desired drugs onto the conveyer part 500.

That is, since the rotating dispensing part rotating part 20 are limited to the third and sixth drug dispensing units U3 and U6 even though all of the dispensing part rotating parts 20 which are moved in position are engaged with the corresponding dispensing parts 110, the rotating dispensing parts 110 may also be limited to the third and sixth drug dispensing units U3 and U6.

When the desired drugs are completely dispensed, the rotation of the rotation power supply parts 30 of the third and sixth drug dispensing units U3 and U6 may be stopped to block the driving force. As a result, each of the position moving parts 10 may return to its original position by the driving force of each of the position moving power supply parts 40 of the first to ninth drug dispensing units UI to U9.

However, the present invention is not limited to the above-described feature in which the driving force of the rotation power supply parts 30 of the third and sixth drug dispensing units U3 and U6 are generated at the same time. For example, the driving force of the rotation power supply parts 30 may be successively generated.

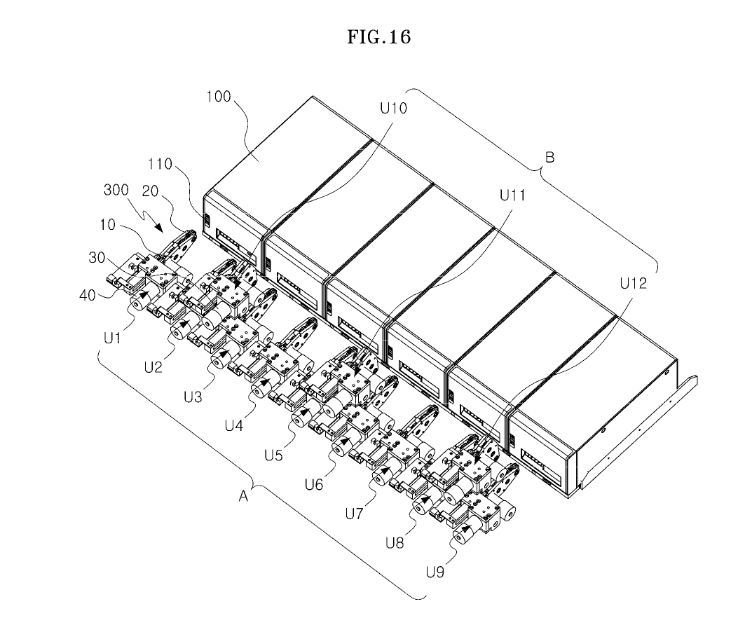

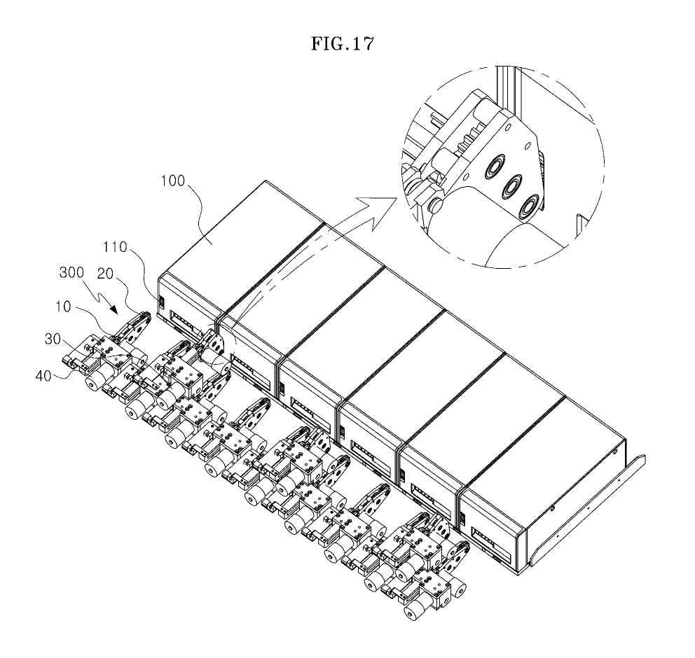

FIG. 16 is schematic perspective view for explaining that the drug dispensing device is applied to drug storage boxes having various sizes according to the present invention, and FIG. 17 is schematic perspective view illustrating an operation state in case of FIG. 16.

Referring to FIGS. 16 and 17, the drug dispensing device 300 may include a first drug dispensing unit floor A and a second drug dispensing unit floor B. The dispensing part rotating parts of the drug dispensing units constituting the second drug dispensing unit floor B may have the same height as those of the drug dispensing units constituting the first drug dispensing unit floor A.

Here, if the drug storage box 100 has a relatively large width as shown in FIGS. 16 and 17, the drug dispensing units corresponding to the drug storage boxes 100 may be included in the first drug dispensing unit floor A and the second drug dispensing unit floor B.

In detail, the drug dispensing unit corresponding to the drug storage box 100 having a relatively large width may be one of a first drug dispensing unit U1, a tenth drug dispensing unit U10, a fourth drug dispensing unit U4, an eleventh drug dispensing unit U11, a seventh drug dispensing unit U7, and a twelfth drug dispensing unit U12.

However, the drug dispensing device 300 according to the present invention may be applied to all of the drug storage boxes 100 having various widths by using the first and second drug dispensing unit floors UI and U2.

A process for dispensing drugs from the drug storage box 100 may be the same as that described with reference to FIGS. 12 to 15.

Although a preferred embodiment of the present invention has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

For example, the present invention is not limited to the feature in which the plurality of drug dispensing units U belong together to realize one drug dispensing device 300. For example, the drug dispensing device 300 may include a single drug dispensing unit U.

In this case, if drugs to be dispensed are contained in at least one drug storage box 100, the drug dispensing device 300 including a single drug dispensing unit U may be successively moved to the drug storage boxes 100 in which the desired drugs are contained to dispense all of the desired drugs.

In the drug dispensing unit and the drug dispensing device including the same according to the present invention, drugs required according to the patient's prescription may be accurately dispensed from the drug storage box.

Also, accuracy in drug dispensing may be improved, and efficiency in drug dispensing may be maximized.

Also, the drug dispensing unit and the drug dispensing device may be applied to drug storage boxes having various sizes.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A drug dispensing unit that rotates a dispensing part to dispense at least one drug from a drug storage box through which the drug is dispensed by an operation of the dispensing part, the drug dispensing unit comprising:
a position moving part having a dispensing part rotating part being moved to contact the dispensing part to allow the dispensing part to rotate;
a rotation force supply part generating driving force for providing rotation force to the dispensing part rotating part, the rotation force supply part being disposed adjacent to the position moving part; and
a position moving power supply part disposed adjacent to the position moving part to provide the driving force with respect to the position movement of the position moving part.

2. The drug dispensing unit of claim 1, wherein the position moving power supply part comprises a pinion gear, and
the position moving part comprises a rack gear that is linearly moved by rotation of the pinion gear to allow the dispensing part rotating part to contact the dispensing part of the drug storage box.

3. The drug dispensing unit of claim 2, wherein the position moving part comprises a rack gear part on which the rack gear is disposed and a rotation support part connected to the rack gear part to rotatably support the dispensing part rotating part.

4. The drug dispensing unit of claim 3, wherein the rotation support part is rotatably connected to the rack gear to improve transmission of the rotation driving force from the dispensing part rotating part due to the contact of the dispensing part.

5. The drug dispensing unit of claim 4, wherein the rotation of the rotation support part by the rack gear is realized within a limited range by a restoring member disposed on a rotation shaft.

6. The drug dispensing unit of claim 2, wherein the position moving power supply part comprises a worm gear comprising a worm and a worm wheel to change a rotation direction, and
the worm wheel is interlocked with the pinion gear to rotate in the same direction as that of the pinion gear.

7. The drug dispensing unit of claim 3, wherein the rotation support part comprises a rotation power interlocking part interlocked with the rotation power supply part to rotate so that the driving force generated by the rotation power supply part is transmitted into the dispensing part rotating part.

8. The drug dispensing unit of claim 1, further comprising a position moving support part disposed on each of both sides of the position moving part to support the position movement of the position moving part.

9. The drug dispensing unit of claim 8, wherein the position moving support part comprises position fixing parts disposed on both sides of the position moving part to prevent the position moving part from being separated and at least one support shaft connecting the position fixing parts to each other, and
the position moving part comprises a through hole through which the support shaft passes to allow the support shaft to be disposed between the position fixing parts.

10. The drug dispensing unit of claim 9, wherein the through hole is successively defined along a position movement direction of the position moving part to define a position movement range of the position moving part.

11. The drug dispensing unit of claim 1, further comprising a movement detection part disposed on a side of the position moving part to detect whether the position moving part is moved.

12. The drug dispensing unit of claim 11, wherein the position moving part comprises an extension part extending toward the movement detection part, and
the movement detection part is provided in at least two within a moving range of the position moving part to detect whether the extension part is moved.

13. A drug dispensing device comprising at least one floor and mounted on drug dispensing equipment, in which a plurality of drug storage boxes for accommodating drugs are mounted on each floor, to operate a dispensing part of each of the drug storage boxes, thereby dispensing at least one drug, the drug dispensing device comprising:
a first drug dispensing unit to an N-th drug dispensing unit according to claim 1, the first drug dispensing unit to the N-th drug dispensing unit being disposed to correspond to the drug storage boxes mounted on the one floor,
wherein the first drug dispensing unit to the N-th drug dispensing unit rotate the dispensing part of the drug storage box, in which a drug to be dispensed is accommodated, to dispense the desired drug (where, N is natural number).

14. The drug dispensing device of claim 13, wherein only a position moving part of the drug dispensing unit corresponding to the drug storage box in which the drug to be dispensed is accommodated among the first drug dispensing unit to the N-th drug dispensing unit is moved in position.

15. The drug dispensing device of claim 14, wherein only a rotation power supply part of the drug dispensing unit, which is moved in position, among rotation power supply parts of the first drug dispensing unit to the N-th drug dispensing unit generates driving force.

16. The drug dispensing device of claim 14, wherein at least one of rotation power supply parts of the drug dispensing units, which are moved in position, and rotation power supply parts of the drug dispensing units, which are not moved in position, among the rotation power supply units of the first drug dispensing unit to the N-th drug dispensing unit generates driving force.

17. The drug dispensing device of claim 13, wherein at least one of position moving parts of the drug dispensing units corresponding to the drug storage boxes, in which drugs to be dispensed are accommodated, and position moving parts of the drug dispensing units corresponding to the drug storage boxes, in which drugs that are not dispensed are accommodated, among the position moving parts of the first drug dispensing unit to the N-th drug dispensing unit is moved to the corresponding drug storage box, and
only a rotation power supply part of the drug dispensing unit corresponding to the drug storage box in which the drugs to be dispensed are accommodated generates driving force.

18. The drug dispensing device of claim 13, wherein, when the drug storage box required for dispensing drugs is provided in plurality, the first drug dispensing unit to the N-th drug dispensing unit simultaneously or successively rotate the dispensing parts of the plurality of drug storage boxes required for dispensing the drugs so that the drugs are dispensed from the plurality of drug storage boxes required for dispensing the drugs.

19. The drug dispensing device of claim 13, wherein portions of the first drug dispensing unit to the N-th drug dispensing unit are disposed at the same height to form a first drug dispensing unit floor, and remaining portions of the first drug dispensing unit to the N-th drug dispensing unit are disposed at the same height on a side of the first drug dispensing unit floor to form a second dispensing unit floor.

20. The drug dispensing device of claim 19, wherein dispensing part rotating parts of the drug dispensing units constituting the second drug dispensing unit floor have the same height as those of dispensing part rotating parts of the drug dispensing units constituting the first drug dispensing unit floor.
